(19) United States
(12) Patent Application Publication
(10) Pub. No.: US 2026/0205012 A1
(43) Pub. Date: Jul. 16, 2026

(54) SWITCHED POWER SUPPLY WITH REDUCED NOISE

(71) Applicant: Google LLC, Mountain View, CA (US)

(72) Inventors: Michael Scot Pate, Mountain View, CA (US); Gemin Li, Mountain View, CA (US); Hsiao Lai-Fong, New Taipei City (TW)

(21) Appl. No.: 19/132,669

(22) PCT Filed: Feb. 10, 2023
(86) PCT No.: PCT/US2023/062372

§ 371 Date: May 23, 2025

(51) Int. Cl. H02M 3/157; H02M 1/00; H02M 3/156

(52) U.S. Cl. CPC H02M 3/157; H02M 1/0025; H02M 1/0054; H02M 3/1563

(57) ABSTRACT

An example method includes determining a switching frequency of a switched mode power supply that includes capacitors; and responsive to determining that the switching frequency of the switched mode power supply is within an audio hand, adjusting the switching frequency of the switched mode power supply to a different frequency within the audio band.

### BACKGROUND

Power supplies may perform switching to generate output signals with desired voltage levels. For instance, a switched mode power supply may include switches that are cycled to convert an input voltage level to an output voltage level. The frequency at which the switches are cycled may dictate a relationship between the input voltage level and the output voltage level. The output of one or more of the switches may be deposited across one or more capacitors.

### SUMMARY

In general, this disclosure is directed to power supplies that operate with switching frequencies in an audio band (e.g., 20 Hz to 20 kHz). The switching frequency of a switched mode power supply may be proportional to an efficiency of the switched mode power supply. For instance, as the switching frequency decreases, the switching losses of the switched mode power supply may decrease. Vice versa, as the switching frequency increases, the switching losses of the switched mode power supply may increase. As such, it may be desirable for a switched mode power supply to operate at a minimum switching frequency, so long as output signal requirements are met (e.g., ripple, adequate current, etc.). In a steady state (e.g., constant load demands), the power supply may settle on a single switching frequency. However, lower switching frequencies may be located in the audio band. Operating a switched mode power supply with a switching frequency in the audio band may not be desirable. For instance, operating a switched mode power supply with a switching frequency in the audio band may emit human-perceptible noise (e.g., as a result of a phenomena called singing capacitors).

In accordance with one or more aspects of this disclosure, a switched mode power supply may be configured to operate with switching frequencies in the audio band. For instance, as opposed to settling on a single frequency in the audio band, the switched mode power supply may hop through multiple switching frequencies in the audio band. As such, the noise emitted by the power supply may similarly be divided across multiple frequencies, which may reduce human perception of said noise. In this way, a switched mode power supply may operate at desirably low switching frequencies, thereby improving efficiency while reducing undesirable noise.

In one example, a method includes determining a switching frequency of a switched mode power supply that includes capacitors, and responsive to determining that the switching frequency of the switched mode power supply is within an audio band, adjusting the switching frequency of the switched mode power supply to a different frequency within the audio band.

In another example, a switched mode power supply includes one or more switches; a capacitor; and a controller configured to: determine a switching frequency of the one or more switches; and adjust, responsive to determining that the switching frequency is within an audio band, the switching frequency to a different frequency within the audio band.

The details of one or more examples of the disclosure are set forth in the accompanying drawings and the description below. Other features, objects, and advantages will be apparent from the description and drawings, and from the claims.

### BRIEF DESCRIPTION OF THE DRAWINGS

FIG. 1 is a block diagram illustrating an example of a system that includes a power supply, in accordance with various aspects of this disclosure.

FIG. 2 is a graph illustrating example signals of a power supply, in accordance with examples of the present disclosure.

FIGS. 3A and 3B are graphs illustrating example noise emitted by a power supply, in accordance with examples of the present disclosure.

FIG. 4 is a flow diagram illustrating example operation of a power supply, in accordance with examples of the present disclosure.

### DETAILED DESCRIPTION

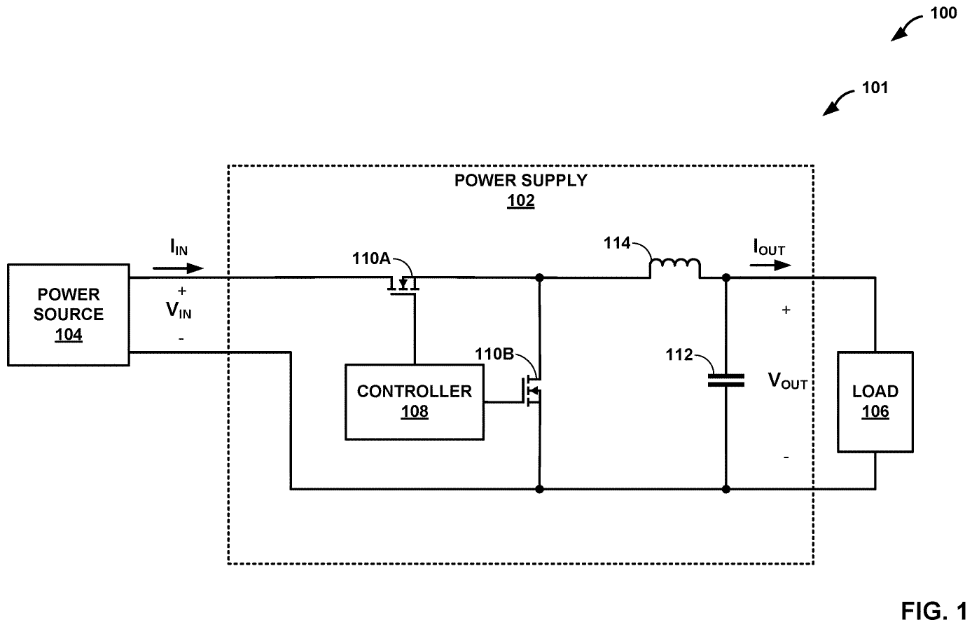

FIG. 1 is a block diagram illustrating an example of a system 100 that includes device 101, which includes power supply 102, in accordance with various aspects of this disclosure. Power supply 102 may receive power from power source 104 and provide power to load 106. Device 101 may be any electronic device, such as a computing device. Example of device 101 include, but are not limited to, a mobile phone (including a so-called “smartphone”), smart glasses, a smart watch, a portable speaker (including a portable smart speaker), a laptop computer, a portable gaming system, a wireless gaming system controller, a television, a monitor, a camera, a desktop computer, a smart home device, and the like. Device 101 includes power supply 102 and may include one or both of power source 104 and load 106.

Power source 104 may represent any component capable of providing electrical energy to power supply 102. As shown in FIG. 1, power source 104 may provide a direct current (DC) power signal to power supply 102 with voltage level V_{IN} and current level IN. Examples of power source 104 include, but are not limited to, external power sources (e.g., an AC adapter), batteries (e.g., batteries included in device 101), and the like.

Load 106 may represent a component that receives and/or operates using electrical energy provided by power supply 102. As shown in FIG. 1, load 106 may receive a DC power signal from power supply 102 with voltage level V_{OUT} and current level I_{OUT}. Examples of load 106 include, but are not limited to, components of device 101 (e.g., a display, a processor, a wireless communication module, etc.), components external to device 101 (e.g., components of another device).

Power supply 102 may be a switched mode power supply configured to convert an input power signal into an output power signal. For instance, power supply 102 may convert an input power signal (received from power source 104) having voltage level V_{IN} and current level I_{IN} into an output power signal (provided to load 106) having voltage level V_{OUT} and current level I_{OUT}. Power supply 102 may be any type of switched mode power supply, such as buck, boost, buck-boost, Cuk (also known as a two-inductor inverting converter), flyback, or any other type of regulated DC/DC converter. As shown in FIG. 1, power supply 102 may include controller 108, switches 110A and 110B (collectively, “switches 110”), capacitor 112, and inductor 114. In some examples, power supply 102 may be, or may be included in, a power management integrated circuit (PMIC) of device 101.

In operation, controller 108 may output control pulses to switches 110 to adjust parameters of the output power signal. Controller 108 may output the control pulses in a variety of control schemes, such as pulse-width modulation (PWM) and pulse-frequency modulation (PFM). When utilizing PWM, controller 108 may adjust a width of the control pulses output to switches 110 while maintaining a constant switching frequency (e.g., in a megahertz (MHz) range). When utilizing PFM, controller 108 may adjust a frequency of the control pulses output to switches 110 (i.e., switching frequency) while maintaining a constant pulse width. For instance, when operating under a PFM scheme, controller 108 may adjust the switching frequency until the output voltage level V_{OUT} reaches a desired value (e.g., between a set output voltage and 0.8 to 1.5 percent above the set output voltage). As such, controller 108 may control, based on an output voltage of power supply 102, the switching frequency by at least outputting a control pulse to switches 110 responsive to the output voltage of power supply 102 falling below a threshold voltage.

The switching frequency of power supply 102 may be proportional to an efficiency of power supply 102. For instance, as the switching frequency of power supply 102 decreases, the switching losses of power supply 102 may decrease. Vice versa, as the switching frequency increases, the switching losses of power supply 102 may increase. As such, it may be desirable for power supply 102 to operate at a minimum switching frequency, so long as output signal requirements are met (e.g., ripple, adequate current, etc.). When operating using PWM or in steady state PFM operation (e.g., constant load demands), controller 108 may settle on a single switching frequency.

Controller 108 may selectively operate in the PWM or the PFM scheme based on a loading of power supply 102. For instance, where power supply 102 is lightly loaded (e.g., Jour is less than a threshold current level), controller 108 may operate power supply 102 using the PFM scheme. Similarly, where power supply 102 is heavily loaded (e.g., I_{OUT} is greater than the threshold current level), controller 108 may operate power supply 102 using the PWM scheme.

In some scenarios, it may be desirable for controller 108 to utilize a switching frequency that is within an audio band (e.g., 20 Hz to 20 kHz). For instance, where power supply 102 is lightly loaded, it may be desirable for controller 108 to utilize a switching frequency within the audio band (e.g., in order to increase efficiency of power supply 102). However, operating power supply 102 with a switching frequency in the audio band may not be desirable. For instance, operating power supply 102 with a switching frequency in the audio band may cause one or more components of power supply 102 to emit human-perceptible noise (e.g., capacitor 112).

In accordance with one or more aspects of this disclosure, controller 108 may operate power supply 102 with switching frequencies in the audio band. For instance, as opposed to settling on a single frequency in the audio band, controller 108 hop through multiple switching frequencies in the audio band. As such, the noise emitted by power supply 102 may similarly be divided across multiple frequencies, which may reduce human perception of said noise. In this way, power supply 102 may operate at desirably low switching frequencies, thereby improving efficiency while reducing undesirable noise.

In operation, controller 108 may determine whether a present switching frequency of power supply 102 is within the audio band. Responsive to determining that the present switching frequency is within the audio band, controller 108 may adjust the switching frequency to a different frequency within the audio band. As one example, responsive to determining that the present switching frequency is 5 kHz, controller 108 may change the switching frequency to 6 kHz.

Controller 108 may resume normal regulation of the switching frequency, which may eventually settle again at the original switching frequency (e.g., 5 kHz) and then again be adjusted to the different frequency. However, by hopping between multiple switching frequencies within the audio band, controller 108 may distribute the resulting noise across multiple frequencies. Such noise distribution may reduce perceptibility of power supply 102, while still enabling use of the more efficient audio band frequencies.

In some examples, controller 108 may perform the aforementioned frequency hopping technique when operating in certain control schemes. For instance, controller 108 may perform the aforementioned frequency hopping technique when power supply 102 is lightly loaded. Controller 108 may determine that power supply 102 is lightly loaded when controller 108 is operating using PFM. As noted above, controller 108 may selectively operate using PFM based on I_{OUT}.

Controller 108 may, in some examples, perform the aforementioned frequency hopping technique when the switching frequency has been static for too long. For instance, controller 108 may determine an amount of time for which the switching frequency of the switched mode power supply has been static (e.g., has not changed, or has not substantially changed) and adjust the switching frequency of the switched mode power supply to the different frequency responsive to determining that the amount of time for which the switching frequency of the switched mode power supply has been static is greater than a threshold amount of time (e.g., 10 milliseconds (ms), 100 ms, 500 ms, 1 second, etc.). The switching frequency may be considered to not be substantially changed when the switching frequency remains within X % (e.g., 2, 4, 5, 10%) of a central frequency (e.g., 98 Hz to 102 Hz where the central frequency is 100 Hz and X % is 2%).

In some examples, controller 108 may adjust the switching frequency to the different switching frequency by increasing the switching frequency. For instance, by increasing the switching frequency, controller 108 may avoid under-supplying load 106 (e.g., under voltage or under current). As one example, controller 108 may adjust the switching frequency by increasing the switching frequency by a pre-determined amount (e.g., 5%, 100 Hz, etc.). As another example, controller 108 may adjust the switching frequency by increasing the switching frequency by a pseudo-random amount.

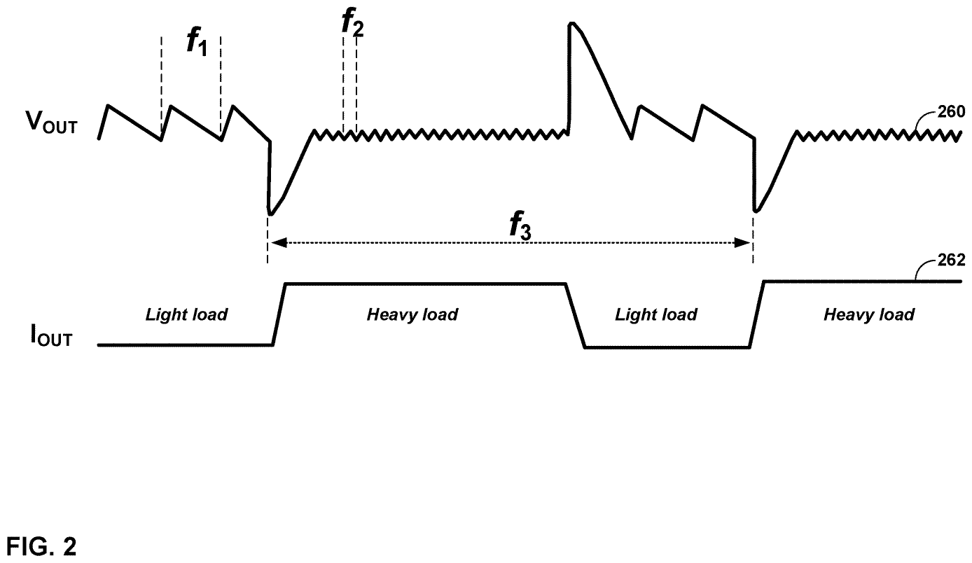

FIG. 2 is a graph illustrating example signals of a power supply, in accordance with examples of the present disclosure. Plot 260 of FIG. 2 illustrates an example output voltage signal of a power supply, such as power supply 102 of FIG. 1 (e.g., plot 260 is an example of V_{OUT} of FIG. 1). Plot 262 of FIG. 2 illustrates an example output current signal of a power supply, such as power supply 102 of FIG. 1 (e.g., plot 262 is an example of I_{OUT} of FIG. 1).

Several frequencies are denoted on FIG. 2. Frequency f₁ may represent a switching frequency of the power supply when the power supply is lightly loaded and controlled using PFM. Frequency f₁ may represent a switching frequency of the power supply when the power supply is heavily loaded and controlled using PWM. Frequency f₃ may represent a periodic transient load caused periodic voltage ripple. Frequencies f₁ and f₃ may have the most acoustic impact. In accordance with one or more aspects of this disclosure, at least frequency f₁ may be adjusted (e.g., when frequency f₁ is within the audio band).

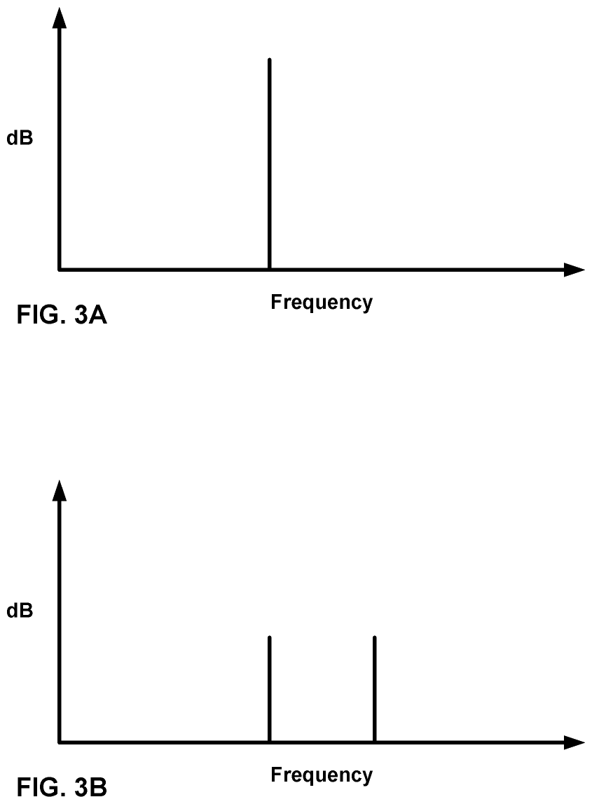

FIGS. 3A and 3B are graphs illustrating example noise emitted by a power supply over a period of time, in accordance with examples of the present disclosure. The vertical axes of FIGS. 3A and 3B may represent an audible noise level in dB and the horizontal axes of FIGS. 3A and 3B may represent switching frequencies of a power supply, such as power supply 102 of FIG. 1.

As can be seen from FIGS. 3A and 3B, by hopping between multiple frequencies, the resulting noise can be distributed across multiple frequencies, thereby reducing human perception of the noise. While illustrated as changing from using a single frequency to using two frequencies, the techniques of this disclosure are not so limited. For instance, a power supply operating in accordance with the techniques of this disclosure may operate by switching between 2, 3, 4, 5, . . . , infinite frequencies within the audio band. The greater number of frequencies used the less the audio noise will be perceptible.

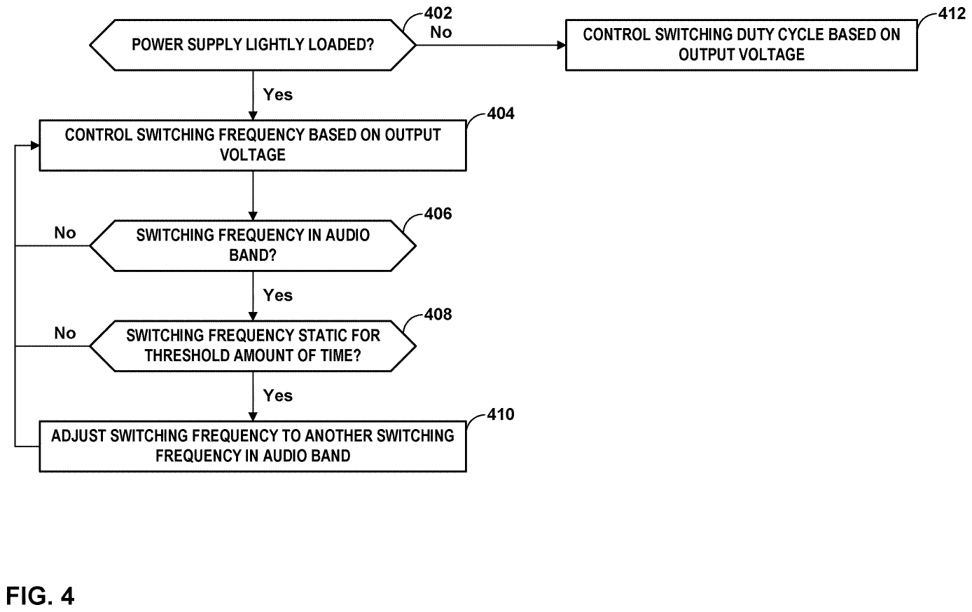

FIG. 4 is a flow diagram illustrating example operation of a power supply, in accordance with examples of the present disclosure. For purposes of explanation, the operations shown in FIG. 4 are described in the context of system 100 of FIG. 1. However, other components may perform the operations of FIG. 4.

Controller 108 of power supply 102 of device 101 of system 100 may determine whether power supply 102 is lightly loaded (402). For instance, controller 108 may determine that a current level of an output power signal generated by power supply 102 is less than a current threshold.

Responsive to determining that power supply 102 is lightly loaded (“Yes” branch of 402), controller 108 may control a switching frequency based on an output voltage of the output power signal (404). For instance, controller 108 may control the frequency at which controller 108 output control signals to switches 110 of power supply 102.

Controller 108 may determine whether the switching frequency is within an audio band (406). For instance, controller 108 may determine that the switching frequency is within the audio band responsive to determining that the switching frequency is greater than 20 hZ and less than 20 kHz.

Responsive to determining that the switching frequency is not within the audio band (“No” branch of 406), controller 108 may continue to control the switching frequency based on an output voltage of the output power signal (404). Responsive to determining that the switching frequency is within the audio band (“Yes” branch of 406), controller 108 may determine whether the switching frequency has been static for a threshold amount of time (408). For instance, controller 108 may determine whether the switching frequency has not changed for longer than the threshold amount of time.

Responsive to determining that the switching frequency has not been static for the threshold amount of time (“No” branch of 408), controller 108 may continue to control the switching frequency based on an output voltage of the output power signal (404). Responsive to determining that the switching frequency is within the audio band and has been static for longer than the threshold amount of time (“Yes” branch of 408), controller 108 may adjust the switching frequency to another frequency within the audio band (410). For instance, controller 108 may adjust the switching frequency to the different switching frequency by increasing the switching frequency. As one example, controller 108 may adjust the switching frequency by increasing the switching frequency by a pre-determined amount (e.g., 5%, 100 hZ, etc.). As another example, controller 108 may adjust the switching frequency by increasing the switching frequency by a pseudo-random amount.

In some examples, in addition to or in place of adjusting the switching frequency, controller 108 may adjust a phase-in threshold at which controller switches from PWM to PFM control. For instance, controller 108 may adjust the loading level at which controller 108 determines that power supply 102 is lightly loaded.

The following numbered examples may illustrate one or more aspects of the disclosure:

Example 1. A method comprising: determining a switching frequency of a switched mode power supply that includes capacitors; and responsive to determining that the switching frequency of the switched mode power supply is within an audio band, adjusting the switching frequency of the switched mode power supply to a different frequency within the audio band.

Example 2. The method of example 1, further comprising: determining whether the switched mode power supply is lightly loaded, wherein adjusting the switching frequency of the switched mode power supply comprises adjusting the switching frequency of the switched mode power supply to the different frequency responsive to determining that the switched mode power supply is lightly loaded.

Example 3. The method of example 2, wherein determining that the switched mode power supply is lightly loaded comprises: determining that the switched mode power supply is being controlled via pulse-frequency modulation (PFM).

Example 4. The method of example 3, wherein determining that the switched mode power supply is not lightly loaded comprises: determining that the switched mode power supply is being controlled via pulse-width modulation (PWM).

Example 5. The method of example 1, further comprising: determining an amount of time for which the switching frequency of the switched mode power supply has been static, wherein adjusting the switching frequency of the switched mode power supply comprises adjusting the switching frequency of the switched mode power supply to the different frequency responsive to determining that the amount of time for which the switching frequency of the switched mode power supply has been static is greater than a threshold amount of time.

Example 6. The method of example 1, wherein adjusting the switching frequency of the switched mode power supply comprises increasing the switching frequency of the switched mode power supply.

Example 7. The method of example 6, wherein increasing the switching frequency of the switched mode power supply comprises increasing the switching frequency of the switched mode power supply by a pre-determined amount.

Example 8. The method of example 6, wherein increasing the switching frequency of the switched mode power supply comprises increasing the switching frequency of the switched mode power supply by a pseudo-random amount.

Example 9. The method of example 1, further comprising: controlling, based on an output voltage of the switched mode power supply, the switching frequency by at least outputting a control pulse to one or more switches of the switched mode power supply responsive to the output voltage of the switched mode power supply falling below a threshold voltage.

Example 10. The method of example 1, wherein the audio band comprises frequencies between 20 Hz and 20 kHZ.

Example 11. A switched mode power supply comprising: one or more switches; a capacitor; and a controller configured to: determine a switching frequency of the one or more switches; and adjust, responsive to determining that the switching frequency is within an audio band, the switching frequency to a different frequency within the audio band.

Example 12. The switched mode power supply of example 11, wherein the controller is further configured to: determine whether the switched mode power supply is lightly loaded, wherein, to adjust the switching frequency of the switched mode power supply, the controller is configured to adjust, responsive to determining that the switched mode power supply is lightly loaded, the switching frequency of the switched mode power supply to the different frequency.

Example 13. The switched mode power supply of example 12, wherein, to determine that the switched mode power supply is lightly loaded, the controller is configured to: determine that the switched mode power supply is being controlled via pulse-frequency modulation (PFM).

Example 14. The switched mode power supply of example 11, wherein the controller is further configured to: determine an amount of time for which the switching frequency of the switched mode power supply has been static, wherein, to adjust the switching frequency of the switched mode power supply, the controller is configured to adjust, responsive to determining that the amount of time for which the switching frequency of the switched mode power supply has been static is greater than a threshold amount of time, the switching frequency of the switched mode power supply to the different frequency.

Example 15. The switched mode power supply of example 11, wherein, to adjust the switching frequency of the switched mode power supply, the controller is configured to increase the switching frequency of the switched mode power supply.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
determining a switching frequency of a switched mode power supply that includes capacitors; and
responsive to determining that the switching frequency of the switched mode power supply is within an audio band, adjusting the switching frequency of the switched mode power supply to a different frequency within the audio band.

2. The method of claim 1, further comprising:
determining whether the switched mode power supply is lightly loaded,
wherein adjusting the switching frequency of the switched mode power supply comprises adjusting the switching frequency of the switched mode power supply to the different frequency responsive to determining that the switched mode power supply is lightly loaded.

3. The method of claim 2, wherein determining that the switched mode power supply is lightly loaded comprises:
determining that the switched mode power supply is being controlled via pulse-frequency modulation (PFM).

4. The method of claim 3, wherein determining that the switched mode power supply is not lightly loaded comprises:
determining that the switched mode power supply is being controlled via pulse-width modulation (PWM).

5. The method of claim 1, further comprising:
determining an amount of time for which the switching frequency of the switched mode power supply has been static,
wherein adjusting the switching frequency of the switched mode power supply comprises adjusting the switching frequency of the switched mode power supply to the different frequency responsive to determining that the amount of time for which the switching frequency of the switched mode power supply has been static is greater than a threshold amount of time.

6. The method of claim 1, wherein adjusting the switching frequency of the switched mode power supply comprises increasing the switching frequency of the switched mode power supply.

7. The method of claim 6, wherein increasing the switching frequency of the switched mode power supply comprises increasing the switching frequency of the switched mode power supply by a pre-determined amount.

8. The method of claim 6, wherein increasing the switching frequency of the switched mode power supply comprises increasing the switching frequency of the switched mode power supply by a pseudo-random amount.

9. The method of claim 1, further comprising:
controlling, based on an output voltage of the switched mode power supply, the switching frequency by at least outputting a control pulse to one or more switches of the switched mode power supply responsive to the output voltage of the switched mode power supply falling below a threshold voltage.

10. The method of claim 1, wherein the audio band comprises frequencies between 20 Hz and 20 kHZ.

11. A switched mode power supply comprising:
one or more switches;
a capacitor; and
a controller configured to:
determine a switching frequency of the one or more switches; and
adjust, responsive to determining that the switching frequency is within an audio band, the switching frequency to a different frequency within the audio band.

12. The switched mode power supply of claim 11, wherein the controller is further configured to:
determine whether the switched mode power supply is lightly loaded,
wherein, to adjust the switching frequency of the switched mode power supply, the controller is configured to adjust, responsive to determining that the switched mode power supply is lightly loaded, the switching frequency of the switched mode power supply to the different frequency.

13. The switched mode power supply of claim 12, wherein, to determine that the switched mode power supply is lightly loaded, the controller is configured to:
determine that the switched mode power supply is being controlled via pulse-frequency modulation (PFM).

14. The switched mode power supply of claim 1, wherein the controller is further configured to:
determine an amount of time for which the switching frequency of the switched mode power supply has been static,
wherein, to adjust the switching frequency of the switched mode power supply, the controller is configured to adjust, responsive to determining that the amount of time for which the switching frequency of the switched mode power supply has been static is greater than a threshold amount of time, the switching frequency of the switched mode power supply to the different frequency.

15. The switched mode power supply of claim 1, wherein, to adjust the switching frequency of the switched mode power supply, the controller is configured to increase the switching frequency of the switched mode power supply.
